(19) United States
(12) Patent Application Publication
(10) Pub. No.: US 2003/0048711 A1
(43) Pub. Date: Mar. 13, 2003

(54) Customization of apparatus by rewriting of control parameter values

(76) Inventor: Akio Hirai, Hamamatsu-shi (JP)

Correspondence Address: Pillsbury Winthrop LLP, Intellectual Property Group, Suite 2800, 725 South Figueroa Street, Los Angeles, CA, 90017-5406, US

(21) Appl. No.: 10/186,273

(22) Filed: Jun. 27, 2002

(30) Foreign Application Priority Data
Jun. 29, 2001 (JP) 2001-199337

(51) Int. Cl. G11B 7/00

(52) U.S. Cl. 369/47.39

(57) ABSTRACT

An information recording apparatus is controllable by a control signal for recording information into a medium. The apparatus is divided into a recording part that is operable by a user to perform a recording operation of information into the medium, and a control part that is operative based on a control parameter for generating the control signal effective to enable the recording part to perform the recording operation. The control part is constructed by a first storage section that stores a default value of the control parameter, which is initially set to enable the recording part to operate normally, a second storage section that is prepared for storing a custom value of the control parameter, which may be optionally set by the user for customizing operation of the recording part, and a generating section that operates when the custom value of the control parameter is actually stored in the second storage section for retrieving the custom value of the control parameter from the second storage section so as to generate tho control signal according to the custom value, thereby enabling the customized operation of the recording part.

### BACKGROUND OF THE INVENTION

1. Field of the Invention

The present invention relates to a control device for generating a control signal to control an object apparatus in accordance with control parameters set for the object apparatus serving as a control target, a media recording apparatus having such a control device, a control method, a control program, and a utility program for rewriting control parameters in a memory.

2. Description of the Related Art

In recent years, various kinds of apparatuses such as electronic apparatuses and electrical apparatuses, each of which mounts a microcomputer (control device), have been developed and sold. The microcomputer includes an MPU (Micro Processing Unit) and a flash ROM (Read Only Memory). Firmware to control the MPU is stored in the flash ROM. The MPU operates according to the firmware to control various sections of the apparatus.

In the related art, however, the operation controlled by the MPU is predetermined by the firmware. Incidentally, the operation may not be performed in meeting with the user's purpose and intention.

### SUMMARY OF THE INVENTION

The present invention is made in consideration of the above-mentioned circumstances. It is an object of the present invention to provide a control device capable of performing control operation of an object apparatus in matching with the user's purpose and intention, a media recording apparatus having such a control device, a control method, a control program, and a utility program for rewriting parameters stored in a memory of the control device.

To accomplish the above object, according to the present invention, there is provided a control device operative based on a control parameter for generating a control signal effective to control an object apparatus which can be operated by a user. The inventive control device comprises a first storage section that stores a default value of the control parameter, which is initially set to enable the object apparatus to operate normally, a second storage section that is prepared for storing a custom value of the control parameter, which may be optionally set by the user for customizing operation of the object apparatus, and a generating section that operates when the custom value of the control parameter is actually stored in the second storage section for retrieving the custom value of the control parameter from the second storage section so as to generate the control signal according to the custom value, thereby enabling the customized operation of the object apparatus.

Preferably, the first storage section comprises a first memory area of a rewritable memory, and the second storage section comprises a second memory area provided in the rewritable memory separately from the first memory area, such that the default value of the control parameter can be updated independently from the custom value of the control parameter by rewriting the first memory area of the rewritable memory.

Preferably, the generating section operates when the second storage section stores an invalid custom value set by the user out of a predetermined valid range for retrieving the default value of the control parameter instead of the invalid custom value so as to generate the control signal.

According to the present invention, there is provided an information recording apparatus controllable by a control signal for recording information into a medium. The information recording apparatus comprises a recording part that is operable by a user to perform a recording operation of information into the medium, and a control part that is operative based on a control parameter for generating the control signal effective to enable the recording part to perform the recording operation. The control part comprises a first storage section that stores a default value of the control parameter, which is initially set to enable the recording part to operate normally a second storage section that is prepared for storing a custom value of the control parameter, which may be optionally set by the user for customizing operation or the recording part, and a generating section that operates when the custom value of the control parameter is actually stored in the second storage section for retrieving the custom value of the control parameter from the second storage section so as to generate the control signal according to the custom value, thereby enabling the customized operation of the recording part. Preferably, the recording part comprises a motor drive section controlled by the control signal for rotating the medium or a disc shape, and e laser drive section controlled by the control signal for irradiating a laser beam onto the rotated medium to optically write the information into the medium.

To accomplish the above object, according to the present invention, there is provided a method of controlling an object apparatus according to a control parameter during the course of an operation of the object apparatus by a user. The inventive method comprises the steps of provisionally storing a default value of the control parameter in a first storage section of the object apparatus, the default value being initially set to enable the object apparatus to operate normally, optionally storing a custom value of the control parameter in a second storage section of the object apparatus, the custom value being potentially set by the user for customizing operation of the object apparatus, detecting when the custom value of the control parameter is actually stored in the second storage section, and retrieving the custom value of the control parameter from the second storage section upon detection of the custom value so as to generate the control signal according to the custom value, thereby enabling the customized operation of the object apparatus.

An inventive control program lo executable by a CPU of an object apparatus for controlling the object apparatus according to a control parameter during the course of an operation of the object apparatus by a user. The control program comprises the steps of accessing a first storage section of the object apparatus, which stores a default value of the control parameter, the default value being initially set to enable the object apparatus to operate normally, accessing a second storage section of the object apparatus, which is prepared for storing a custom value of the control parameter, the custom value being optionally set by the user for customizing operation of the object apparatus, detecting when the custom value of the parameter is actually stored in the second storage section, and retrieving the custom value of the parameter from the second storage section upon detection of the custom value so as to generate the control signal according to the custom value, thereby enabling the customized operation or the object apparatus.

An inventive utility program is executable by a computer connected to an object apparatus for assisting a user to set a control parameter in a rewritable memory of the object apparatus. The inventive utility program comprises the steps of accessing the rewritable memory to retrieve therefrom a current value of the control parameter, prompting the user to input a new value of the control parameter in place of the current value of the control parameter, acquiring the new value of the control parameter which is inputted by the user in response to the prompting, and rewriting the current value of the control parameter stored in the rewritable memory with the acquired new value, thereby setting the control parameter.

### BRIEF DESCRIPTION OF THE DRAWINGS

FIG. 1 is a perspective view showing an external appearance of an optical disc recording apparatus according to an embodiment of the present invention.

FIG. 2 is a block diagram showing a hardware constitution of the optical disc recording apparatus.

FIG. 3 is a diagram for explaining an OPC processing.

FIG. 4 is a conceptual diagram showing recording areas of a flash ROM.

FIG. 5 is a diagram showing an example of control parameter tables provided in the flash ROM.

FIG. 6 is a diagram for explaining a method of setting control parameters.

FIG. 7 is a flowchart for explaining a processing of generating a control signal.

FIG. 8 is a diagram for explaining a method of obtaining firmware.

### DETAILED DESCRIPTION OF THE EMBODIMENTS

An embodiment of the present invention will now be described hereinbelow with reference to the drawings. In the following embodiment, an optical disc recording apparatus such as a CD-R (Compact Disc-Recordable) drive will be explained as an example of the media recording apparatus having a control device according to the present invention.

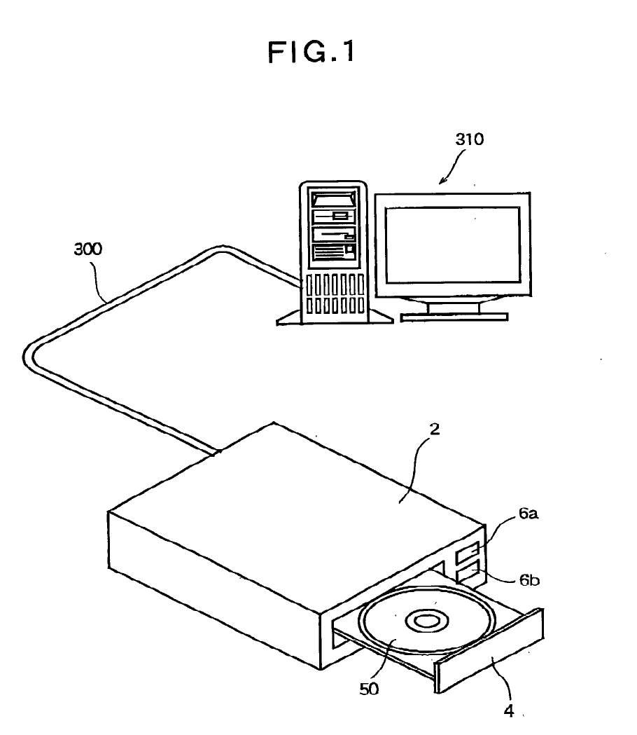

FIG. 1 is a perspective view showing the external appearance of an optical disc recording apparatus according to the embodiment of the present invention. As shown in the drawing, a cabinet 2 of the optical disc recording apparatus is shaped Into a substantially flat rectangular parallelepiped form. A tray 4 is disposed on the front surface of the optical disc recording apparatus. The tray 4 is disposed so that it can be pushed into and pulled from the cabinet 2, whereby an optical disc 50 set on the tray a can be inserted to or ejected from the cabinet.

LEDs (Light Emitting Diode) 6a and 6b are arranged on the front surface of the optical disc recording apparatus. The LEDs 6a and 6b may light or blink in accordance with the operating condition of the optical disc recording apparatus to notify the user of the operating condition of the optical disk recording apparatus.

On the other hand, on the rear surface of the optical disc recording apparatus, a cable connector (not shown) is arranged to connect the optical disc recording apparatus to a personal computer 310 (hereinbelow, referred to as a “PC”) through a cable 300. The optical disc recording apparatus is connected to the PC 310 through the cable 300, so that the optical disc recording apparatus can transmit or receive data to/from the PC. As interface standards used for the connection of the optical disc recording apparatus and the PC 310, any desired standards can be used as long as the optical disc recording apparatus can transmit or receive data to/from the PC. For example, SCSI (Small computer System Interface) Standard, IEEE (Institute of Electrical and Electronic Engineers) 1394 Standard, ATAPI (AT Attachment Packet Interface) Standard, and USB (Universal Serial Bus) Standard can be used.

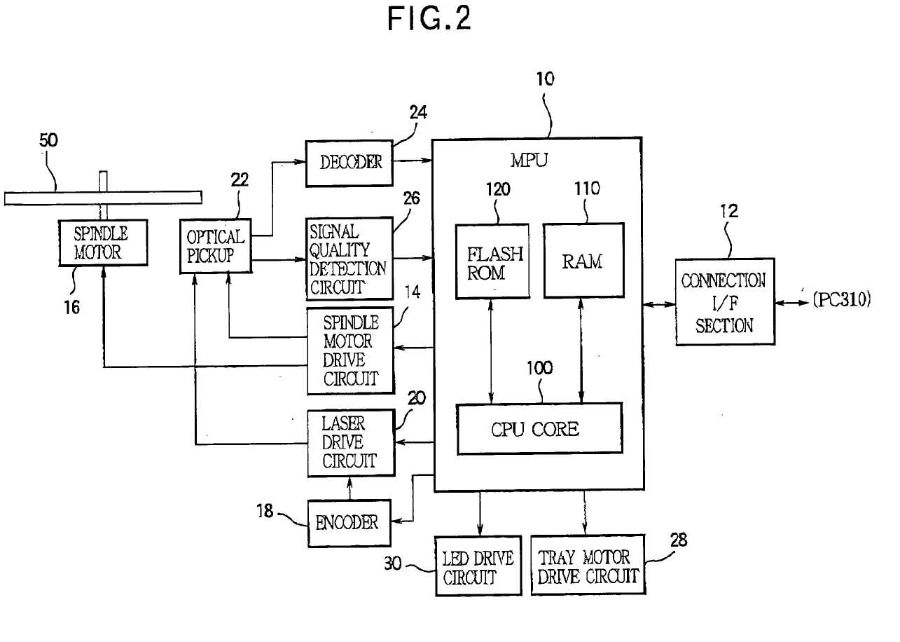

A constitution of hardware of the optical disc recording apparatus will now be described. FIG. 2 is a block diagram showing the hardware constitution of the optical disc recording apparatus. As shown In the drawing, the optical disc recording apparatus has such a constitution that MPU 10 controls various sections of the optical disc recording apparatus. The detailed description regarding the MPU 10 will be made later.

In the same drawing, a connection I/F section 12 is connected to the PC 310 through the cable 300 under the control of the MPU 10 The connection I/F section 12 controls the transmission and reception of data performed between the optical disc recording apparatus and the PC 310.

Under the control of the MPU 10, a spindle motor drive circuit 14 drives a spindle motor 16 to rotate an optical disc 50. More specifically, the spindle motor drive circuit 14 includes a servo circuit. When obtaining a speed designation signal to designate a rotational speed of the spindle motor 16 from the MPU 10, the spindle motor drive circuit 14 supplies a driving voltage corresponding to the designated rotational speed to the spindle motor 16, thereby controlling the rotational speed of the spindle motor 16 to the designated rotational speed

Generally, when the driving voltage supplied to the spindle motor 16 is fixed, the rotational speed of the spindle motor 16 varies depending on loads (for example, air resistance or moment of inertia applied to the optical disc 50 during rotation) applied to the spindle motor 16. The servo circuit, provided for the spindle motor drive circuit 14, has a servo function (so-called feedback circuit) to detect the rotational speed of the spindle motor 16 and to control the driving voltage so as to reduce a deviation between the detected rotational speed and the rotational speed designated by the MPU 10, so that a fluctuation in rotational speed of the spindle motor 16 due to the loads can be reduced and the rotational speed of the spindle motor 16 can be controlled accurately.

An encoder 18 obtains data (hereinbelow, referred to as “record data”) to be recorded to the optical disc 50 from the MPU 10, perform EFM (Eight-to-Fourteen Modulation) modulation to such a data signal, and outputs the modulated signal to a laser drive circuit 20.

The laser drive circuit 20 drives a laser beam source (not shown) provided for an optical pickup 22 in accordance with the EMF-modulated data signal to record the data to the optical disc 50. The laser drive circuit 20 has a function to obtain a laser power designation signal to designate the value of the laser power from the MPU 10 to control the value of the laser power of the laser beam source of the optical pickup 22 to the designated laser power value.

The optical pickup 22 has a function to detect the EMF-modulated data signal (hereinbelow, referred to as a “reproduction signal”) recorded In the optical disc 50, and then outputs the detected reproduction signal to a decoder 24 and a signal quality detection circuit 26.

The decoder 24 demodulates the obtained reproduction signal and then outputs the demodulated signal to the MPU 10. The MPU 10 outputs the demodulated signal as reproduced information to the PC 310 connected through the connection I/F section 12.

The signal quality detection circuit 26 specifies a β value (asymmetry) as a parameter regarding the quality of the reproduction signal from the obtained reproduction signal and then outputs the value to the MPU 10. The β value is defined by (a+b)/(a−b), where reference symbol a denotes the peak level (positive code) of an EFM signal waveform of a reproduction signal and reference symbol b denotes the bottom level thereof.

In such a constitution, prior to actual data recording, the optical disc recording apparatus according to the present embodiment executes so-called OPC (Optimum Power Control) to specify the optimum value of the laser power with respect to the recording speed used to record data to the optical disc 50. The OPC will now be described hereinbelow.

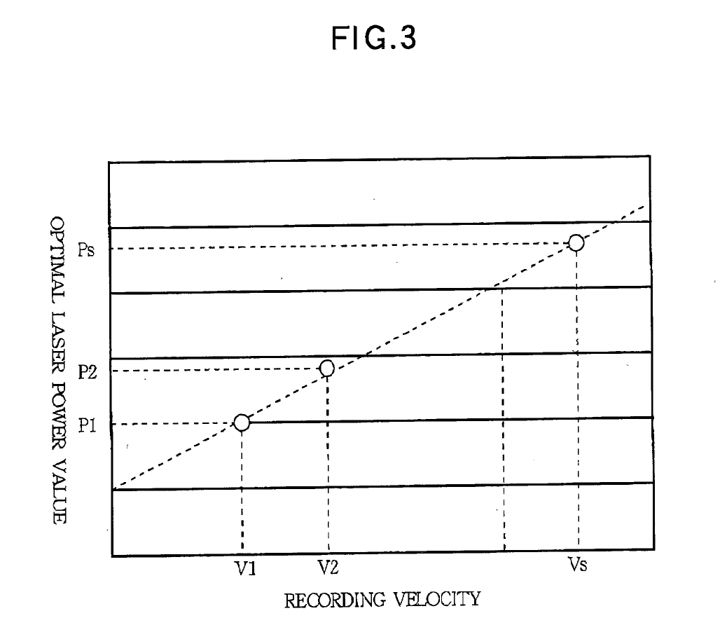

FIG. 3 is a graph showing a relationship between a recording linear velocity and the optimum laser power value. In the drawing, a linear velocity Vs indicates a linear velocity (recording speed) used in actual recording. The MPU 10 selects some levels of linear velocities lower than the recording speed Vs. In FIG. 3, linear velocities V1 and V2 denote the selected linear velocities for the execution of the OPC.

Subsequently, the MPU 10 outputs a speed designation signal to the spindle motor drive circuit 14 to control the recording linear velocity to the linear velocity V1. Next, the MPU 10 outputs sample data for test recording to the encoder 18 and also outputs a laser power designation signal to the laser drive circuit 20 to execute test recording of the sample data while fixing the linear velocity to the linear velocity V1 and changing the laser power value.

The signal quality detection circuit 26 detects the reproduction signal quality of the sample data recorded in this manner. More specifically, when the linear velocity is fixed to the linear velocity V1, the signal quality detection circuit 26 outputs the laser beam power values and the β values indicative of the reproduction signal qualities of the sample signals recorded on the basis of the laser team power values to the MPU 10.

Subsequently, the MPU 10 specifies the β value that is the closest to a predetermined β value (for example, 0.04) from among the obtained β values and then sets the laser beam power value corresponding to the specified β value to an optimum laser power value P1 at the linear velocity V1.

Similarly, the MPU 10 obtains another optimum laser power value P2 corresponding to the linear velocity V2. Subsequently the MPU 10 specifies the characteristics of the optimum laser power value for the linear velocity using linear function on the basis of the linear velocities V1 and V2 and the optimum laser power values p1 and p2 corresponding to the respective linear velocities.

Next, the MPU 10 specifies an optimum laser power value Ps corresponding to the recording speed Vs on the basis of the optimum laser power value corresponding to the linear velocity specified by the linear function. In the actual recording, in order to set the laser power value to the optimum laser sower value Ps, the MPU 10 outputs a laser power designation signal to designate the optimum laser power value Ps to the laser drive circuit 20. Consequently, the record data is recorded at the optimum laser power value corresponding to the recording speed.

In the above-mentioned OPC, the two linear velocities V1 and V2 are set as the linear velocities used for the test recording. When more linear velocities used for the test recording are selected and the optimum laser power values corresponding to the respective linear velocities are obtained, the characteristics of the optimum laser power value corresponding to the linear velocity are specified with higher precision. Consequently, the signal quality in the recording of data is improved.

Referring back to FIG. 2, a tray motor drive circuit 28 drives a tray motor (not shown) to insert or draw the tray 4 under the control of the MPU 10. The tray motor drive circuit 28 supplies a driving voltage corresponding to a tray speed designation signal outputted from the MPU 10 to the tray motor, thereby controlling an open/close speed of the tray 4.

An LED drive circuit 30 controls the lighting states of the LEDS 6a and 6b under the control of the MPU 10. More specifically, the MPU 10 has a function to determine whether the optical disc 50 is a music CD (CD conformable to CD-DA Standard)on the basis of TOC (Table of Contents) data recorded as read-in information on the innermost side of the optical disc 50. When detecting that the disc is a music CD, the MPU 10 generates an LED control signal to alternately blink the LEDs 6a and 6b and then outputs the signal to the LED drive circuit 30. When receiving the LED control signal, the LED drive circuit 30 supplies a driving voltage to each of the LEDs 6a and 6b in accordance with the LED control signal.

The constitution of the MPU 10 will now be described.

As shown in FIG. 2, the MPU 10 has a CPU (Central Processing Unit) core 100. The CPU core 100 performs various control processings. That is, in the optical disc recording apparatus according to the present embodiment, the CPU core 100, provided for the MPU 10, is configured to control the respective sections of the optical disc recording apparatus. An RAM (Random Access Memory) 110 is used as a work area of the CPU 100. A calculation result derived by the CPU 100 and other various data is temporarily stored into the RAM 110.

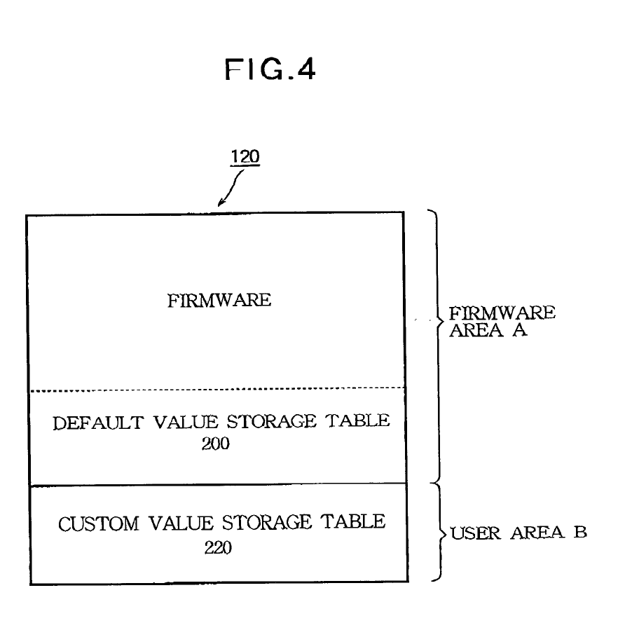

The MPU 10 further has a flash ROM 120. The flash ROM 120 is a rewritable non-volatile memory and, as shown in FIG. 4, has a firmware area A and a user area B.

Firmware is a main program indicating the control procedure of the CPU core 100 and is stored in the firmware area A. The CPU core 100 executes the control operation in accordance with the firmware.

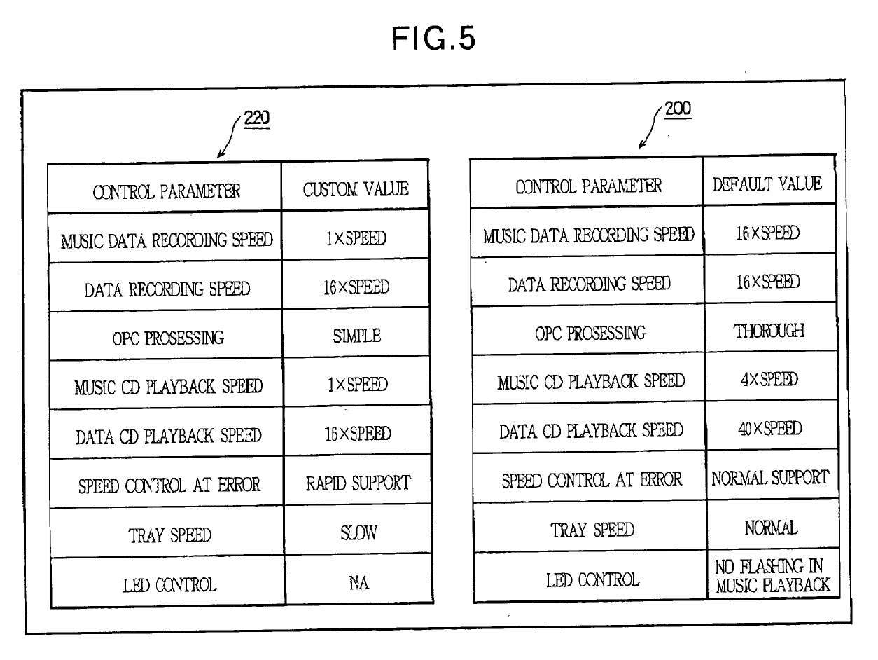

As shown in FIG. 4, a default value storage table 200 is provided in the firmware area A. A custom value storage table 220 has been stored in the user area B. FIG. 5 is a conceptual diagram showing an example of the default value storage table 200 and the custom value storage table 220.

As shown in the same drawing, in the default value storage table 200 and the custom value storage table 220, control parameters used at a time when the CPU core 100 generates a control signal are associated with values of the control parameters. As mentioned above, as the control signals, there are the speed designation signal outputted to the spindle motor drive circuit 14 and the laser power signal outputted to the laser drive circuit 20. The CPU core 100 generates the control signals in accordance with the control parameters.

To describe in more detail, default values of the control parameters have been provisionally stored in the default value storage table 200. The default values are predetermined by the maker of the optical disc recording apparatus and are set so that the optical disc recording apparatus can exert the normal or basic performance when the user uses the optical disc recording apparatus. On the other hand, the custom values are set by the user of the optical disc recording apparatus and are set in accordance with the user's purpose and intention. The operation according to the present embodiment performed at a time when the user sets the control parameters will be described later.

Referring further to FIG. 5, the control parameters set in the present embodiment will now be described. As shown in the same drawing, as the control parameters stored in the default value storage table 200 and the custom value storage table 210, there are a music data recording-speed parameter, a data recording-speed parameter, and an OPC processing parameter as parameters regarding the data recording.

The music data recording-speed parameter indicates a recording speed in recording music data to the optical disc 50. As the music data, there is PCM (Pulse Code Modulation) sound source data.

On the other hand, the data recording-speed parameter denotes a recording speed in recording, for example, a data file or a program file to the optical disc 50. The music data recording-speed parameter and the data recording-speed parameter are set within a range from the highest recording speed (for example, 40×speed) to a basic recording speed (1×recording speed) of the optical disc recording apparatus.

Consequently, for example, in case of the user who desires to record music data only at much expense in time, the user can set the music data recording-speed parameter to the basic speed and set tho data recording-speed parameter to the highest recording speed.

Subsequently, the OPC processing parameter denotes whether the OPC processing is performed in thorough. As a value of the OPC processing parameter, either a value indicative of “simple” or a value indicative of “thorough” is selected. The value of a linear velocity for rest recording selected in the OPC processing in the case where the value of the OPC processing parameter denotes “simple” differs from that in case where the value of the OPC processing parameter denotes “thorough”.

Specifically, when “simple” is set as a value of the OPC processing parameter, as shown in FIG. 3, only two points of the linear velocities V1 and V2 are selected. On the other hand, when “thorough” is set, the CPU core 100 selects more levels of the linear velocities. Consequently, when “simple” is set as the OPC processing parameter, the number of points to measure the optimum laser power value is smaller than that in case where “thorough” is set. Accordingly, time required for the OPC processing is reduced but the precision in setting the characteristics of the optimum laser power value for the linear velocity using the linear function is degraded, resulting in the degradation of the quality of a signal to be recorded. When the OPC processing parameter is set so, the user can choose a reduction in time at recording rather than the quality of the signal to be recorded. It is a matter of course that the OPC processing parameters can be set so as to individually correspond to music data recording time and data recording time.

Subsequently, as control parameters regarding a playback speed (linear velocity at playback) of the optical disc 50, there are a music CD playback-speed parameter and a data CD playback-speed parameter.

The music CD playback-speed parameter indicates a playback speed in case of playing back, for example, a music CD. On the other hand, the data CD playback-speed parameter denotes a playback speed in case of playing back a data CD in which, for example, a data file or a program has teen recorded. The music CD playback-speed parameter and the data CD playback-speed parameter can be set within a range from the highest playback speed to the basic speed of the optical disc recording apparatus.

Accordingly, when playing back a music CD that does not require high playback speed generally, the user can set the music CD playback-speed parameter to a low speed such as “1×speed”. Further, the setting results in a reduction of noise caused in association with high speed rotation of the spindle motor 16.

On the other hand, due to a stain such as dust or a scratch deposited on the reading surface (data recording surface) of the optical disc 50, the quality of a reproduction signal is degraded. Consequently, in some cases, record data cannot normally be read out, namely, a reading error may be caused. According to the present embodiment, an error-occurrence-time speed control parameter is set as a control parameter to cope with the error. As values indicated by the error-occurrence-time speed control parameter, “rapid support” and “normal support” are set.

In a case where the error-occurrence-time speed control parameter is set to “rapid support”, when a reading error occurs, the playback speed of the optical disc 50 is switched to a low speed such as the basic speed and, after that, a reproduction signal is detected.

On the other hand, in the case where the error-occurrence-time speed control parameter is set to “normal support”, even when a reading error occurs, a reproduction signal is detected on condition that the playback speed of the optical disc 50 is held constant. When the reading error occurs predetermined number of times, the playback speed is reduced.

Accordingly, when the error-occurrence-time speed control parameter is set to “rapid support”, the playback speed is rapidly reduced upon occurrence of a reading error. Consequently, the reproduction signal is read out more correctly, hence the number of invalid reading times is reduced and processing time required to cope with the occurrence of the reading error is reduced.

Subsequently, a tray speed parameter in set as a control parameter indicative of the open/close speed of the tray 4. As the tray speed parameters, two values of “normal” and “low speed” are set. The tray 4 is operated at a speed according to the value of the tray speed parameter. Furthermore, when the tray speed parameter is set to “normal”, the open/close speed of the tray 4 denotes a speed set in shipping (namely a default value).

On the other hand, when the tray speed parameter is set to “low speed” the open/close speed of the tray 4 is reduced as compared with the case where it is set to “normal”.

Accordingly, when the driving noise of the tray motor upon insertion or drawing of the tray 4 disturbs the user, he or she can set the tray speed parameter to “low speed”, so that the tray-motor driving soise can be reduced.

As a control parameter to control the lighting of the LEDs 6a and 6b, an LED control parameter in act. Furthermore, two values of “the presence of blinking for music playback” and “the absence of blinking for music playback” are set as the LED control parameters. When the LED control parameter is set to “the presence of blinking for music playback”, the LEDs 6a and 6b (refer to FIG. 1) arranged on the front surface of the optical disc recording apparatus are alternately blinked at playback of a music CD to notify the user of the playback of the music CD.

On the other hand when the LED control parameter is seat to “the absence of blinking for music playback”, the LEDs 6a and 6b perform the operations similar to those at playback of a data CD.

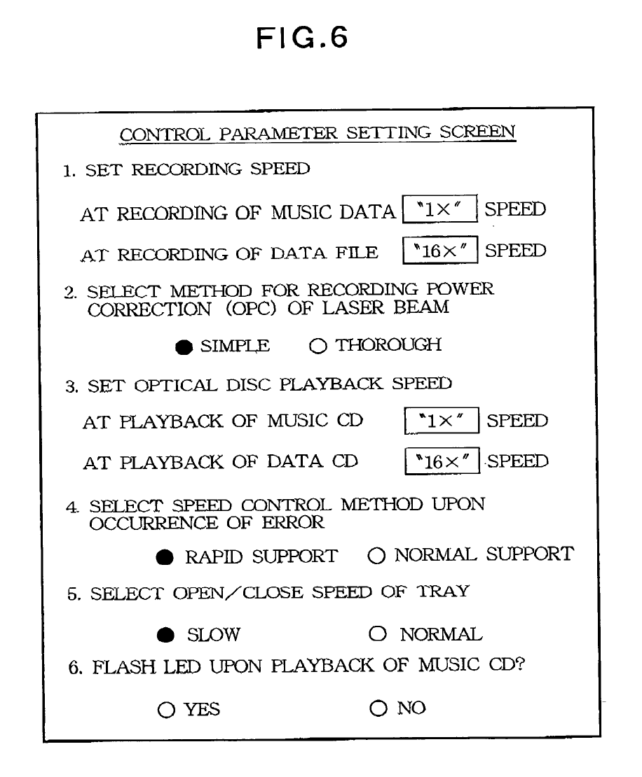

In the present embodiment, a utility program having such a function that the user can set control parameters may be installed in the PC 310 to which the optical disc recording apparatus is connected. When the user sets the control parameters, the user starts the user setting program and operates an input operating unit of the PC 210 in accordance with a parameter setting screen displayed on a display unit of the PC 310, so that he or she can set the values of the above-mentioned control parameters. FIG. 6 is a block diagram showing an example of the parameter setting screen.

As shown in the same drawing, the values of the above-mentioned control parameters can be inputted. The custom value of each control parameter inputted by the user is supplied from the PC to the MPU 10 of the optical disc recording apparatus through the connection I/F section 12. Subsequently, the CPU core 100 of the MPU 10 registers the obtained custom value to the custom value storage table 220.

In this manner, the values of the control parameters set by the user are recorded in the custom value storage table 220. In the parameter setting screen shown in FIG. 6, the user does not need to set values of all the displayed parameters. Furthermore, in the custom value storage table 220, regarding a control parameter that is not set by the user, a value indicative of the absence of the custom value (for example, “NA: No Answer”) is recorded.

When the CPU core 100 generates a control signal to control the various sections of the apparatus, the CPU core 100 refers the custom values of the control parameters set by the user. A processing of generating the control signal will now be described hereinbelow. In the following explanation, a case where the CPU core 100 controls the various sections so as to perform the OPC processing will be described.

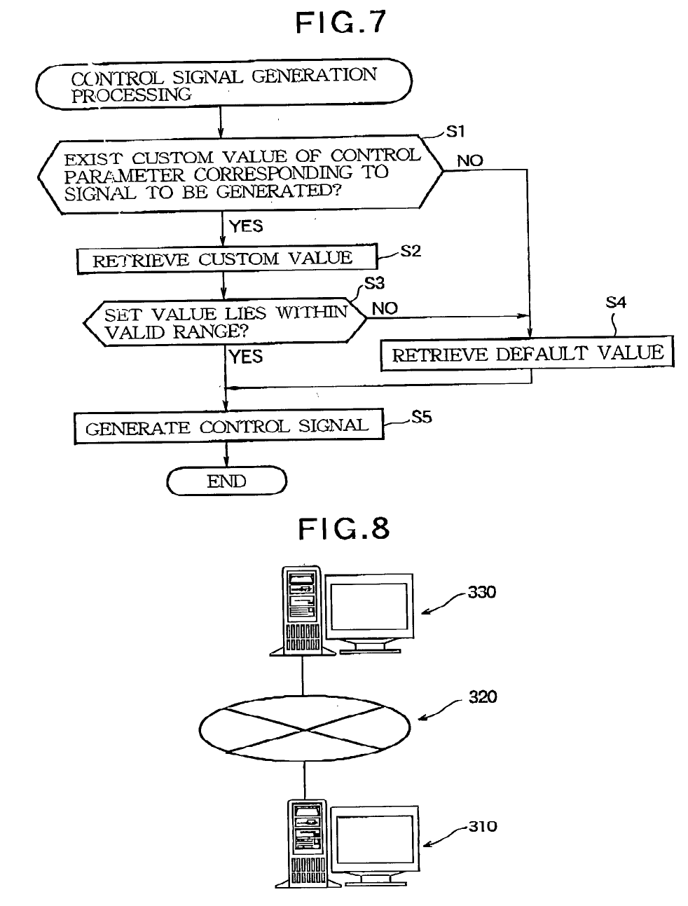

FIG. 7 is a flowchart showing the control signal generation processing. As shown in the same drawing, the CPU core 100 first accesses the custom value storage table 220 stores in the user area β of the flash ROM 120 to detect whether the custom value corresponding to the OPC processing parameter is set by the user (step S1). As the result of the determination, when it is detected that the custom value is set, the CPU core 100 obtains the custom value corresponding to the OPC processing parameter (step S2).

Subsequently, the CPU core 100 detects whether the obtained custom value lies within a range covering valid set values (step S3). That is, the range of the values that may be valid as control parameters is predetermined so as to be specific to the optical disc recording apparatus. In step S3, the CPU 100, determines whether the custom value lies within the valid range.

On the other hand, when the determination result in steps S2 and S3 denotes “NO”, the CPU core 100 accesses the default value storage table 200 stored in the firmware area A to obtain a default value of the OPC processing parameter (step S4),

Consequently, when the custom value is set as the control parameter, the custom value is selected in preceding to the default value. In the case where the custom value is set, when the custom value lies out of the range covering valid set values, the default value is selected, thereby preventing the erroneous operation of the CPU core 100.

Subsequently, the CPU core 100 generates a control signal at step S5 in accordance with the value of the OPC processing parameter obtained in step S2 or S4. That is, when the value of the OPC processing parameter denotes “simple”, the CPU core 100 outputs the control signal to each section of the apparatus in order to determine the optimum laser power corresponding to the actual recording speed from the optimum laser power values at the two points of the linear velocities V1 and V2 (refer to FIG. 3). When the value of the OPC processing parameter indicates “thorough”, the CPU core 100 outputs the control signal to each section of the apparatus in order to determine the optimum laser power value corresponding to the actual recording speed from the optimum laser power values at three linear velocities whose number is greater than that in case of “simple”. As mentioned above, the CPU core 100 preferentially selects the custom value as the control parameter, so that the control is effected according to the user's intention and purpose.

In the present embodiment, as shown in FIG. 8, the firmware stored in the flash ROM 120 and the user setting program stored in the PC can be obtained from a server 330 connected to a network 320 such as the Internet.

The server 330 has stored the latest firmware and user setting program. The user operates the PC 310 to obtain the programs from the server 330, so that he or she can use the latest programs.

Furthermore, when the latest firmware is downloaded from the server 330, the PC 310 outputs the firmware to the optical disc recording apparatus connected thereto through the cable 300. When obtaining the firmware through the connection I/F section 12, the CPU core 100 deletes the old recorded contents in the firmware area A in the flash ROM 120 and then stores the latest firmware obtained from the PC 310 into the firmware area A. In this manner, the latest firmware is stored in the flash ROM 120. As long as the control parameters set by the user are stored separately from the firmware area A in the flash ROM, even when the firmware is updated to the latest ones the user does not need to set the custom parameters again. Moreover, not a group of complicated functions and a group of commands but the parameters alone are stored in the user area B. Accordingly, In association with the update of the firmware, it is easy to avoid that the consistency of the latest firmware with the default parameters stored in the user area B is lost.

As mentioned above, in the present embodiment, in preceding to the default value of the control parameter stored in the firmware area A in the flash ROM 120, the CPU core 100 selects the custom value of the control parameter stored in the user area B, and outputs the control signal to each section of the apparatus in accordance with the selected custom value. Consequently, the CPU core 100 can allow the optical disc recording apparatus to perform the operation according to the user's purpose and intention.

<Modifications>

The above-mentioned embodiment has basically been explained as an example of the present invention and can be freely modified within the scope of the present invention. Various modifications will now be described hereinbelow.

(1) For example, in the foregoing embodiment, the optical disc recording apparatus having the control device according to the present invention has been described. The present invention can be applied to any control device of any apparatus device that outputs a control signal to each section of the apparatus in accordance with firmware stored in a flash ROM.

(2) In the optical disc recording apparatus according to the present embodiment, the spindle motor 16, the tray motor drive circuit 28, the OPC processing, and the like have been explained as examples of sections controlled by the CPU core 100. A control target Is not limited to them. That is, any target operated according to a control signal from the CPU core 100 can be controlled

(3) Furthermore, according to the present embodiment, although one flash ROM is divided into the firmware area A and the user area A, the example is not fixed to this arrangement. That is, the device can be configured to have a first flash ROM to store a firmware area A and a second flash ROM to store a user area.

Lastly referring back again to FIGS. 1 and 2, the inventive control program is executable by a CPU 100 of the object apparatus 2 for controlling the object apparatus 2 according to a control parameter during the course of an operation of the object apparatus 2 by a user. The control program is carried out by the steps of accessing a first storage section 200 of the object apparatus, which stores a default value of the control parameter, the default value being initially set to enable the object apparatus 2 to operate normally, accessing a second storage section 220 of the object apparatus, which is prepared for storing a custom value of the control parameter, the custom value being optionally set by tho user for customizing operation of the object apparatus, detecting when the custom value of the parameter is actually stored in the second storage section 220, and retrieving the custom value of the parameter from the second storage section 220 upon detection of the custom value so as to generate the control signal according to the custom value, thereby enabling the customized operation of the object apparatus 2.

The inventive utility program is also executable by the computer 310 connected to the object apparatus 2 for assisting a user to set a control parameter in a rewritable memory 120 of the object apparatus 2. The inventive utility program is carried out by the steps of accessing the rewritable memory 120 to retrieve therefrom a current value of the control parameter, prompting the user to input a new value of the control parameter in place of the current value of the control parameter, acquiring the new value of the control parameter which is inputted by the user in response to the prompting, and rewriting the current value of the control parameter stored in the rewritable memory 120 with the acquired new value, thereby setting the control parameter.

As mentioned above, according to the present invention, there are provided a control device, which can perform the control operation according to the user's purpose and intention, a media recording apparatus having the control device, a control method, a control program, and a memory rewriting program.

What is claimed is:

1. A control device operative based on a control parameter for generating a control signal effective to control an object apparatus which can be operated by a user, the control device comprising:
a first storage section that stores a default value of the control parameter, which is initially set to enable the object apparatus to operate normally;
a second storage section that is prepared for storing a custom value of the control parameter, which may be optionally set by the user for customizing operation of the object apparatus; and
a generating section that operates when the custom value of the control parameter is actually stored in the second storage section for retrieving the custom value of the control parameter from the second storage section so as to generate the control signal according to the custom value, thereby enabling the customized operation of the object apparatus.

2. The control device according to claim 1, wherein the first storage section comprises a first memory area of a rewritable memory and the second storage section comprises a second memory area provided in the rewritable memory separately from the first memory area, such that the default value of the control parameter can be updated independently from the custom value of the control parameter by rewriting the first memory area of the rewritable memory.

3. The control device according to claim 1, wherein the generating section operates when the second storage section stores an invalid custom value set by the user out of a predetermined valid range for retrieving the default value of the control parameter instead of the invalid custom value so as to generate the control signal.

4. An information recording apparatus controllable by a control signal for recording information into a medium, the apparatus comprising:
a recording part that is operable by a user to perform a recording operation of information into the medium; and
a control part that is operative based on a control parameter for generating the control signal effective to enable the recording part to perform the recording operation, wherein the control part comprises:
a first storage section that stores a default value of the control parameter, which is initially set to enable the recording part to operate normally;
a second storage section that is prepared for storing a custom value of the control parameter, which may be optionally set by the user for customizing operation of the recording part; and
a generating section that operates when the custom value of the control parameter is actually stored in the second storage section for retrieving the custom value of the control parameter from the second storage section so as to generate the control signal according to the custom value, thereby enabling the customizes operation of the recording part.

5. The information recording apparatus according to claim 4, wherein the recording part comprises a motor drive section controlled by the control signal for rotating the medium of a disc shape, and a laser drive section controlled by the control signal for irradiating a laser beam onto the rotated medium to optically write the information into the medium.

6. A method of controlling an object apparatus according to a control parameter during the course of an operation of the object apparatus by a user, the method comprising the steps of:
provisionally storing a default value of the control parameter in a first storage section of the object apparatus, the default value being initially set to enable the object apparatus to operate normally;
optionally storing a custom value of the control parameter in a second storage section of the object apparatus, the custom value being potentially set by the user for customizing operation of the object apparatus;
detecting when the custom value of the control parameter is actually stored in the second storage section; and
retrieving the custom value of the control parameter from the second storage section upon detection of the custom value so as to generate the control signal according to the custom value, thereby enabling the customized operation of the object apparatus.

7. A control program executable by a CPU of an object apparatus for controlling the object apparatus according to a control parameter during the course of an operation of the object apparatus by a user the control program comprising the steps of:
accessing a first storage section of the object apparatus, which stores a default value of the control parameter, the default value being initially set to enable the object apparatus to operate normally;
accessing a second storage section of the object apparatus, which is prepared for storing a custom value of the control parameter, the custom value being optionally set by the user for customizing operation of the object apparatus;
detecting when the custom value of the parameter is actually stored in the second storage section; and
retrieving the custom value of the parameter from the second storage section upon detection of the custom value so as to generate the control signal according to the custom value, thereby enabling the customized operation of the object apparatus.

8. A utility program executable by a computer connected to an object apparatus for assisting a user to set a control parameter in a rewritable memory of the object apparatus, the utility program comprising the steps of:
accessing the rewritable memory to retrieve therefrom a current value of the control parameter;
prompting the user to input a new value of the control parameter in place of the current value of the control parameter;
acquiring the new value of the control parameter which is inputted by the user in response to the prompting; and
rewriting the current value of the control parameter stored in the rewritable memory with the acquired new value, thereby setting the control parameter.
